(19) United States
(12) Patent Application Publication
(10) Pub. No.: US 2011/0235198 A1
(43) Pub. Date: Sep. 29, 2011

(54) LENS DRIVE DEVICE

(75) Inventors: Yukio Furuya, Nagano (JP); Takeshi Sue, Nagano (JP); Akira Mori, Nagano (JP)

(73) Assignee: NIDEC SANKYO CORPORATION, Nagano (JP)

(21) Appl. No.: 13/120,250

(22) PCT Filed: Sep. 17, 2009
(86) PCT No.: PCT/JP2009/004680

§ 371 Date: May 26, 2011

(30) Foreign Application Priority Data
Sep. 22, 2008 (JP) 2008-242547

(51) Int. Cl. G02B 7/04

(52) U.S. Cl. 359/824; 359/823

(57) ABSTRACT

A lens drive device may include a support body, a movable body which holds a lens, a magnetic drive mechanism which drives the movable body, a spring member provided with an arm part whose both ends are connected with the movable body and the support body. Only one piece of the spring member may be disposed between an end part on one side in a lens optical axis direction of the movable body and the support body. A displacement prevention mechanism may be structured at an end part on the other side in the lens optical axis direction of the movable body. The displacement prevention mechanism may include a protruded part and a recessed part.

### CROSS REFERENCE TO RELATED APPLICATIONS

This is a U.S. national stage of international application No. PCT/JP2009/004680, filed on Sep. 17, 2009. Priority under 35 U.S.C. §119(a) and 35 U.S.C. §365(b) is claimed from Japanese Application No. 2008-242547, filed Sep. 22, 2008 the disclosure of which is also incorporated herein by reference.

### TECHNICAL FIELD

The present invention relates to a lens drive device in which a movable body provided with a lens is driven in a lens optical axis direction by a magnetic drive mechanism.

### BACKGROUND

A camera which is mounted on a cell phone with a camera, a digital camera or the like is provided with a lens drive device, which includes a support body, a movable body that holds a lens, and a magnetic drive mechanism for driving the movable body in a lens optical axis direction. Further, a first spring member is disposed between an imaging element side end part of the movable body and the support body, and a second spring member is disposed between an object side end part of the movable body and the support body. Each of the first spring member and the second spring member is a flat spring-shaped gimbal spring which is provided with a plurality of arm parts. Therefore, the first spring member and the second spring member apply spring forces in a lens optical axis direction, a radial direction perpendicular to a lens optical axis, and a circumferential direction around the lens optical axis. Accordingly, a positional control in the lens optical axis direction of the movable body can be performed by utilizing a thrust force by the magnetic drive mechanism and spring forces in the lens optical axis direction of the first spring member and the second spring member, and displacement in the radial direction of the movable body and circumferential displacement of the movable body can be restrained (see Patent Literature 1).

In the lens drive device as described above, with downsizing of the movable body, in a case that the weight of the movable body is reduced or a thrust force generated by the magnetic drive mechanism is lowered, the spring forces of the first spring member and the second spring member are required to be made smaller. However, when a thickness or a width of the arm part is reduced in order to make the spring force smaller, strength, characteristics and stress resistance performance of the first spring member and the second spring member are lowered. Therefore, the present inventors propose that the number of the spring members is reduced and, as a result, the spring force for the movable body can be made smaller and reducing of a thickness or a width of the arm part can be avoided.

On the other hand, a lens drive device has been known in which only one piece of spring member is used for one movable body. This lens drive device is provided with a thrust displacement prevention mechanism in which a protruded part provided on a magnet support body and a protruded part provided on the movable body are abutted with each other so that displacement more than a predetermined distance in the lens optical axis direction (thrust direction) of the movable body is prevented and, as a result, detachment of the movable body is prevented (see Patent Literatures 2 and 3).

Further, in the lens drive device disclosed in Patent Literatures 2 and 3, an inclining displacement prevention mechanism is adopted in which a rib provided on an outer peripheral face of a magnet support body is slid on an inner peripheral face of the movable body, or a rib formed on an inner peripheral face of the movable body is slid on an outer peripheral face of a magnet support body to prevent the movable body to be inclined with respect to the lens optical axis.
[PTL 1] Japanese Patent Laid-Open No. 2007-226011
[PTL 2] Japanese Patent Laid-Open No. 2003-207708
[PTL 3] Japanese Patent Laid-Open No. 2003-295033

However, in the structures described in Patent Literatures 2 and 3, movement in the lens optical axis direction is restricted and inclination of the movable body is prevented between the outer peripheral face of the magnet support body and the inner peripheral face of the movable body and thus a space for arranging a displacement prevention mechanism is required between the outer peripheral face of the magnet support body and the inner peripheral face of the movable body. Therefore, the structures described in Patent Literatures 2 and 3 cannot be applied to a small lens drive device, especially to a lens drive device whose dimension in the radial direction is small.

Further, in the structures described in Patent Literatures 2 and 3, a mechanism is not provided for preventing the movable body from turning around the lens optical axis. Therefore, when the movable body is going to be turned around the lens optical axis due to an impact which is applied from the outside, all the turning force from the movable body is applied to one piece of the spring member and thus a fatal malfunction such as plastic deformation may be easily occurred in the spring member.

In view of the problem described above, at least an embodiment of the present invention provides a lens drive device which is suitable for downsizing and in which, even when the number of the spring member is reduced to one piece in order to reduce its size, displacement in the radial direction of the movable body, circumferential displacement around the lens optical axis of the movable body, and inclination of the movable body with respect to the lens optical axis are prevented.

### SUMMARY

At least an embodiment of the present invention provides a lens drive device including a support body, a movable body which holds a lens, a magnetic drive mechanism which drives the movable body in a lens optical axis, and a spring member which is provided with an arm part whose both ends are connected with the movable body and the support body. Only one piece of the spring member is disposed between an end part on one side in a lens optical axis direction of the movable body and the support body, and a displacement prevention mechanism is structured at an end part on the other side in the lens optical axis direction of the movable body. The displacement prevention mechanism is comprised of a protruded part which is extended in the lens optical axis direction from one of the movable body and the support body and a recessed part which is provided in the other of the movable body and the support body and opened in the lens optical axis direction and into which the protruded part is fitted so that displacement in a radial direction perpendicular to the lens optical axis direction of the movable body, circumferential displacement around the lens optical axis of the movable body, and inclination of the movable body with respect to the lens optical axis are prevented.

In the lens drive device in accordance with at least an embodiment of the present invention, only one spring member provided with arm parts such as a gimbal spring is used at an end part of only one side in the lens optical axis direction of the movable body and thus a spring force of the spring member can be made larger in comparison with a case that two conventional springs are used. Therefore, with downsizing of the movable body, even when a weight of the movable body is reduced or a thrust force generated by the magnetic drive mechanism is reduced, the arm part has a margin in which its thickness and width are made thinner. Accordingly, strength, a spring characteristic, a stress resistance performance and the like of the spring member are not lowered. In this case, displacement in the radial direction, circumferential displacement of the movable body and inclination of the movable body may be easily occurred at the end part on the other side of the movable body. However, in at least an embodiment of the present invention, the displacement prevention mechanism is structured at an end part on the other side of the movable body by using a protruded part which is extended in the lens optical axis direction from one of the movable body and the support body and a recessed part which is provided in the other of the movable body and the support body and opened in the lens optical axis direction and into which the protruded part is fitted so that displacement in a radial direction perpendicular to the lens optical axis direction of the movable body, circumferential displacement around the lens optical axis of the movable body, and inclination of the movable body with respect to the lens optical axis are prevented. Therefore, even when one spring member is used, unnecessary displacement of the movable body is restrained. In addition, the displacement prevention mechanism which is structured as described above utilizes both end faces of the movable body and the support body which are faced with each other in the lens optical axis direction and thus, a space for providing the displacement prevention mechanism is not required between the support body and the movable body in the radial direction. Therefore, at least an embodiment of the present invention is suitable for a small lens drive device, especially for a lens drive device whose dimension in the radial direction is small. In addition, in the displacement prevention mechanism adopted in at least an embodiment of the present invention, only one mechanism prevents displacement in the radial direction of the movable body, inclination of the movable body, and circumferential displacement of the movable body. In addition, when the protruded part and the recessed part are structured so that excessive movement longer than a predetermined distance in the lens optical axis direction of the movable body is prevented, only one mechanism is also capable of preventing excessive movement longer than a predetermined distance in the lens optical axis direction of the movable body. Therefore, even when the movable body is going to turn around the lens optical axis by an impact applied from the outside, a circumferential force is not applied to the spring member from the movable body. Accordingly, even in a case that one piece of the spring member is used, a fatal malfunction such as plastic deformation is not occurred in the spring member.

In at least an embodiment of the present invention, it is preferable that a coil and a magnet which are used in the magnetic drive mechanism are disposed between the end part on the one side and the end part of the other side in the lens optical axis direction of the movable body. In other words, it is preferable that the coil and the magnet are disposed so as to be interposed in the lens optical axis direction by the spring member and the displacement prevention mechanism. In other words, in at least an embodiment of the present invention, only one piece of spring member is used at only the end part on one side in the lens optical axis direction of the movable body and, at the end part on the other side of the movable body, the displacement prevention mechanism is structured by utilizing both end faces of the movable body and the support body which are faced with each other in the lens optical axis direction. Therefore, the magnetic drive mechanism can be disposed between the spring member and the displacement prevention mechanism in the lens optical axis direction. Accordingly, in comparison with a case that the magnetic drive mechanism is disposed at one side in the lens optical axis direction, when the movable body is driven by the magnetic drive mechanism, the movable body is not inclined. Further, a region in the lens optical axis direction between the spring member and the displacement prevention mechanism is utilized as an arrangement space for the magnetic drive mechanism and thus the size of the lens drive device is suitably reduced. In this specification, the phrase “interposed between the spring member and the displacement prevention mechanism” does not mean that the entire displacement prevention mechanism is disposed so as to interpose the magnetic drive mechanism and means that the displacement prevention mechanism is structured at the end part on the other side with respect to the spring member.

In at least an embodiment of the present invention, it is preferable that the protruded part is integrally formed with one of the movable body and the support body in the lens optical axis direction. According to this structure, a separate structural member is not required to be added for structuring the protruded part. Therefore, since the number of part items is reduced, the cost of the lens drive device is reduced. Further, when the protruded part is formed so as to protrude from the support body in the lens optical axis direction and the recessed part into which the protruded part is fitted is formed in the movable body, the displacement prevention mechanism can be structured by utilizing a free space of the movable body and thus the size of the lens drive device can be appropriately reduced.

In at least an embodiment of the present invention, it is preferable that each of the support body and the movable body is provided with an external shape which is substantially a rectangular prism shape, and the displacement prevention mechanism is disposed at a position corresponding to corner portions of the support body and the movable body when viewed in the lens optical axis direction. The corner portion is a free space where the circular lens is not located and thus, when the displacement prevention mechanism is disposed at the corner position, the displacement prevention mechanism can be arranged reasonably even when the size of the lens drive device is reduced.

In this case, it is preferable that the magnet which is used in the magnetic drive mechanism is a flat plate-shaped permanent magnet that is disposed at a position corresponding to a side portion of the support body when the support body is viewed in the lens optical axis direction. When the flat plate-shaped magnet is adopted, the magnet is easily manufactured and inexpensive. Further, when the coil which is used in the magnetic drive mechanism is structured so that the coil is wound around in a rectangular tube shape so as to face the flat plate-shaped permanent magnet, the protruded part and the recessed part structuring the displacement prevention mechanism can be disposed on the inner side in the corner portion of the coil which is formed in the rectangular tube shape and thus the size is preferably reduced. Specifically, when the movable body is structured so as to provide with a lens holder formed in a cylindrical tube shape which holds the lens, and a rectangular coil holder which holds the lens holder on an inner side and whose outer peripheral side face is wound around with the coil, a space can be secured reasonably in which the displacement prevention mechanism is arranged on an inner side of the corner portion of the rectangular coil holder and between the lens holder in the cylindrical tube shape and the rectangular coil holder. Further, it may be structured that the protruded part is a shaft pin which is protruded from the support body in a long and thin shape in the lens optical axis direction, and the recessed part is provided with an opening part which is formed in the coil holder so that the shaft pin is fitted.

In at least an embodiment of the present invention, it is preferable that the displacement prevention mechanism is disposed at plural rotationally symmetrical positions with the lens optical axis as a center. According to this structure, when displacement of the movable body is prevented by the displacement prevention mechanism, the movable body can be surely prevented from being inclined.

In at least an embodiment of the present invention, it is preferable that a pressing member is further provided which presses the movable body toward a home position where the movable body is located at the home position in a state that the magnetic drive mechanism does not generate a thrust force in the lens optical axis direction. According to this structure, even when an external force is applied, the movable body is surely held at the home position.

In at least an embodiment of the present invention, it is preferable that the pressing member applies rotationally symmetrical pressing forces to the movable body with the lens optical axis as a center. According to this structure, when the magnetic drive mechanism drives the movable body, the movable body is not inclined.

In the lens drive device in accordance with at least an embodiment of the present invention, only one spring member provided with arm parts is used at an end part of only one side in the lens optical axis direction of the movable body and thus a spring force of the spring member can be made larger in comparison with a conventional case that two springs are used. Therefore, with downsizing of the movable body, even when a weight of the movable body is reduced or a thrust force generated by the magnetic drive mechanism is reduced, the arm part has a margin in which its thickness and width are made thinner. Accordingly, strength, a spring characteristic, a stress resistance performance and the like of the spring member are not lowered. Further, the displacement prevention mechanism is structured at an end part on the other side of the movable body by using a protruded part which is extended in the lens optical axis direction from one of the movable body and the support body and a recessed part which is provided in the other of the movable body and the support body and opened in the lens optical axis direction and into which the protruded part is fitted so that displacement in a radial direction perpendicular to the lens optical axis direction of the movable body, circumferential displacement around the lens optical axis of the movable body, and inclination of the movable body with respect to the lens optical axis are prevented. Therefore, even when one spring member is used, unnecessary displacement of the movable body can be restrained. In addition, the displacement prevention mechanism which is structured as described above utilizes both end faces of the movable body and the support body which are faced with each other in the lens optical axis direction and thus, a space for providing the displacement prevention mechanism is not required between the support body and the movable body in the radial direction. Therefore, at least an embodiment of the present invention is suitable for a small lens drive device, especially for a lens drive device whose dimension in the radial direction is small. In addition, in the displacement prevention mechanism adopted in at least an embodiment of the present invention, only one mechanism prevents displacement in the radial direction of the movable body, inclination of the movable body, and circumferential displacement of the movable body. Therefore, even when the movable body is going to turn around the lens optical axis by an impact applied from the outside, a circumferential force is not applied to the spring member from the movable body. Accordingly, even in a case that one piece of the spring member is used, a fatal malfunction such as plastic deformation is not occurred in the spring member.

### BRIEF DESCRIPTION OF DRAWINGS

Embodiments will now be described, by way of example only, with reference to the accompanying drawings which are meant to be exemplary, not limiting, and wherein like elements are numbered alike in several Figures, in which:

FIG. 1(a) is an outward appearance view showing a lens drive device in accordance with at least an embodiment of the present invention which is viewed from obliquely above and FIG. 1(b) is its exploded perspective view.

FIGS. 2(a) through 2(e) are explanatory views showing main members which are used in a lens drive device in accordance with at least an embodiment of the present invention.

FIGS. 3(a) and 3(b) are explanatory views showing structures in which occurrence of an air damper phenomenon is prevented by a displacement prevention mechanism in a lens drive device in accordance with at least an embodiment of the present invention.

FIG. 4 is an explanatory view schematically showing an operation of a lens drive device in accordance with at least an embodiment of the present invention.

### DESCRIPTION OF EMBODIMENTS

An embodiment of the present invention will be described below with reference to the accompanying drawings. A lens drive device which will be described below is capable of being mounted on various electronic apparatuses in addition to a cell phone with a camera. For example, the lens drive device may be mounted on a thin-type digital camera, a PHS, a PDA, a bar code reader, a monitoring camera, a camera for rear confirmation in a car, a door having optical authentication function or the like.

### (Entire Structure of Lens Drive Device)

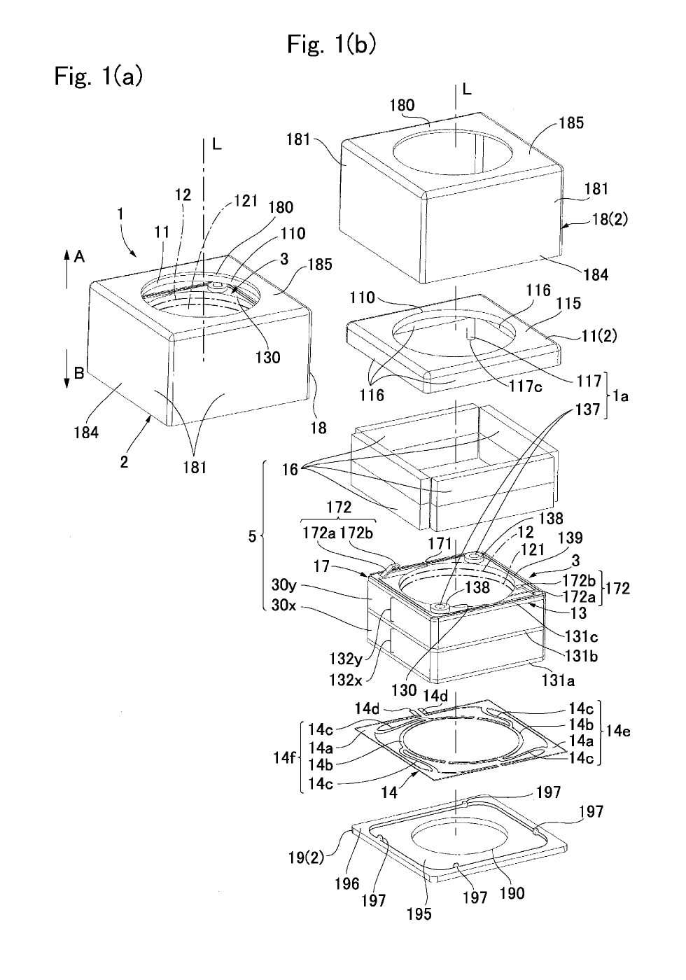

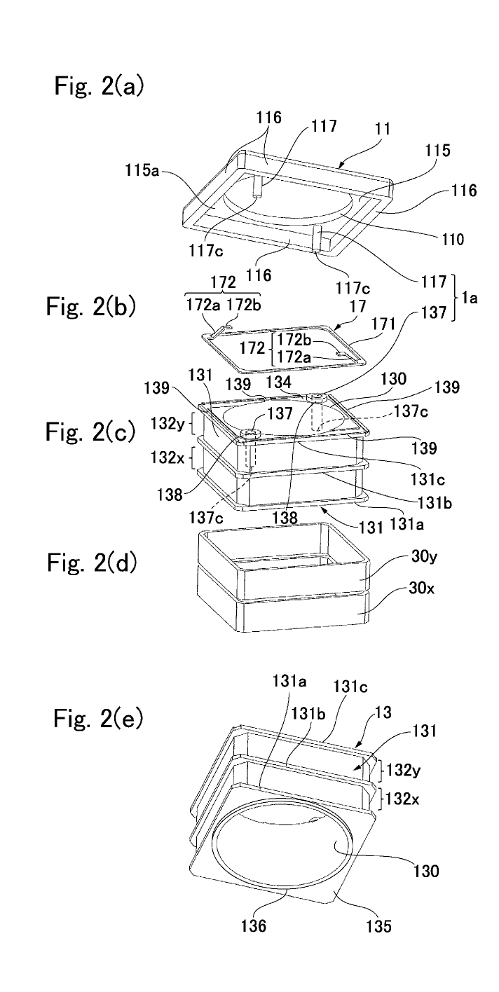

FIG. 1(a) is an outward appearance view showing a lens drive device in accordance with an embodiment of the present invention which is viewed from obliquely above and FIG. 1(b) is its exploded perspective view. FIGS. 2(a) through 2(e) are explanatory views showing main members which are used in a lens drive device in accordance with at least an embodiment of the present invention. FIG. 2(a) is a perspective view showing a spacer which is viewed from an imaging element side, FIG. 2(b) is a perspective view showing a pressing member which is viewed from an object to be photographed side, FIG. 2(c) is a perspective view showing a coil holder which is viewed from an object to be photographed side, FIG. 2(d) is a perspective view showing coils which are viewed from an object to be photographed side, and FIG. 2(e) is a perspective view showing the coil holder which is viewed from the imaging element side, each of which is used in a lens drive device in accordance with an embodiment of the present invention.

In FIGS. 1(a) and 1(b), a lens drive device 1 in this embodiment is a device in which one or a plurality of lenses 121 is moved along a lens optical axis “L” in both of an “A”-direction (front side) toward an object to be photographed (object side) and a “B”-direction (rear side) toward an opposite side to the object to be photographed (image element side/image side) in a thin camera which is used in a cell phone with a camera or the like. The lens drive device 1 is formed in a substantially rectangular parallelepiped shape. The lens drive device 1 generally includes a movable body 3 having the lens 121 and a fixed diaphragm in its inside, a magnetic drive mechanism 5 for moving the movable body 3 along the lens optical axis “L” direction, and a support body 2 on which the magnetic drive mechanism 5, the movable body 3 and the like are mounted. The movable body 3 is provided with a lens holder 12 in a cylindrical tube shape which holds the lens 121 and the fixed diaphragm, and a coil holder 13 which holds a first coil 30x and a second coil 30y described below on its outer peripheral side face. The lens holder 12 is held in a center hole 130 of the coil holder 13. In the movable body 3, an upper face part 134 located on the object to be photographed side of the coil holder 13 is fixed with a pressing member 17 described below (see FIG. 2(b)).

The support body 2 is provided with an imaging element holder 19 which is formed in a rectangular plate shape for holding an imaging element (not shown) on an imaging element side, a yoke 18 in a box-like shape which is placed on the imaging element holder 19 from an object to be photographed side, and a spacer 11 in a rectangular plate shape which is disposed on an inner side of the yoke 18.

A circular incident window 180 for taking light from an object to be photographed into the lens 121 is formed at a center of an upper plate part 185 of the yoke 18 which covers the movable body 3 on the object to be photographed side.

The spacer 11 is provided with an upper plate part 115 which is superposed on the upper plate part 185 of the yoke 18s on the imaging element side and four side plate parts 116 which are protruded to the imaging element side from four side parts of the upper plate part 115. A circular incident window 110 for taking light from an object to be photographed into the lens 121 is formed at a center of the upper plate part 115. Further, the spacer 11 is formed with two protruded parts 117 (see FIG. 2(a)), which are formed in a shaft shape, i.e., a long and thin shaft pin that is protruded toward the imaging element side at diagonal positions interposing the incident window 110 on a face 115a (end face) on the imaging element side of the upper plate part 185. The protruded part 117 may be a round bar shape or a square bar shape. The protruded part 117 is, specifically as described below, fitted into a recessed part 137 which is formed in the movable body 3 to structure a displacement prevention mechanism 1a.

A hole 190 for guiding incident light to the imaging element (not shown) is formed at a center of a bottom plate portion 195 of the imaging element holder 19. Further, a face on the object to be photographed side of the bottom plate portion 195 of the imaging element holder 19 is formed with a frame part 196 which is protruded on the object to be photographed side along its outer peripheral edge. Small projections 197 are formed at predetermined positions of an inner peripheral edge of the frame part 196. The frame part 196 is used for fixing a spring member 14 described below. The projection 197 is protruded toward the object to be photographed side slightly higher than the frame part 196 and abutted with the bottom part 135 of the movable body 3 (coil holder 13) to determine a home position where the movable body 3 is located at a position nearest to the imaging element.

In this embodiment, the yoke 18 is made of a ferromagnetic plate such as a steel plate and structures together with magnets 16 an interlinkage magnetic field generating body for generating an interlinkage magnetic field in the first coil 30x and the second coil 30y which are held by the coil holder 13. The interlinkage magnetic field generating body structures the magnetic drive mechanism 5 together with the first coil 30x and the second coil 30y which are wound around an outer peripheral face of the coil holder 13.

### (Detail Structure of Magnetic Drive Mechanism 5)

In the lens drive device 1 in this embodiment, when viewed in the lens optical axis “L” direction, the lens 121 is circular but the yoke 18 used for the support body 2 is formed in a rectangular box-like shape. Therefore, the yoke 18 is provided with a rectangular tube-shaped body part 184 and the upper plate part 185 formed with the incident window 180 on an upper face side of the rectangular tube-shaped body part 184. In this embodiment, the rectangular tube-shaped body part 184 is formed in a rectangular tube shape and is provided with four side plate parts 181 at respective positions corresponding to sides of a quadrangle when viewed in the lens optical axis “L” direction.

In this embodiment, a magnet 16 is fixed to each of inner faces of four side plate parts 181 and each of the magnets 16 is formed of a rectangular flat plate-shaped permanent magnet. Each of the four magnets 16 is divided into two pieces in the optical axis “L” direction and is magnetized so that its inside face and its outside face are magnetized to be different from each other. The four magnets 16 are, for example, magnetized so that inside faces of their upper half portions are magnetized to be an “N”-pole and their outside faces are magnetized to be an “S”-pole, and are magnetized so that inside faces of their lower half portions are magnetized to be an “S”-pole and their outside faces are magnetized to be an “N”-pole. Therefore, arrangements of the magnetic poles of the permanent magnets adjacent to each other are the same as each other in the four magnets 16. In accordance with an embodiment of the present invention, it may be structured so that arrangements of the magnetic poles of the magnets 16 adjacent to each other are the same as each other in the four magnets 16, or may be structured so that arrangements of the magnetic poles of the magnets 16 adjacent to each other are different from each other.

The movable body 3 is provided with the lens holder 12 in a cylindrical tube shape which holds the lens 121 and the like, and the rectangular coil holder 13 (see FIG. 2(c)) in which the coil (first coil 30x and second coil 30y) is wound around its outer peripheral side face. A side wall portion of the movable body 3 is structured by the lens holder 12 and the coil holder 13.

In this embodiment, when the rectangular coil holder 13 is viewed in the lens optical axis “L” direction, its inner peripheral shape is circular but four outer peripheral side faces 131 are formed at respective positions corresponding to four sides of a quadrangle. Rib-shaped protruded parts 131a, 131b and 131c are formed at both end parts and a center position in the lens optical axis “L” direction on the outer peripheral side faces 131 of the coil holder 13 over the entire periphery of the coil holder 13. A recessed part between the rib-shaped protruded part 131a formed at the imaging element side end part and the rib-shaped protruded part 131b formed at the center position is a first coil winding part 132x, and a recessed part between the rib-shaped protruded part 131c formed at the object side end part and the rib-shaped protruded part 131b formed at the center position is a second coil winding part 132y. In accordance with an embodiment of the present invention, in order to reduce the weight of the coil holder 13, rectangular through holes (not shown) may be formed in each of the first coil winding part 132x and the second coil winding part 132y of the coil holder 13 so as to avoid the corner portions of a quadrangle.

In the coil holder 13 structured as described above, the first coil 30x is wound around the first coil winding part 132x and the second coil 30y is wound around the second coil winding part 132y (see FIG. 2(d)). In this embodiment, the first coil winding part 132x and the second coil winding part 132y are formed in a quadrangle shape when viewed in the lens optical axis “L” direction and thus both of the first coil 30x and the second coil 30y are wound around in a rectangular tube shape. Further, in all of the four magnets 16, two faces divided in the lens optical axis “L” direction are magnetized in different poles from each other and thus winding directions of the first coil 30x and the second coil 30y are opposite to each other.

The coil holder 13 which is structured as described above is disposed on an inner side of the yoke 18. As a result, four side parts of the first coil 30x and the second coil 30y are respectively faced to the magnets 16 which are fixed to the inner face of the rectangular tube-shaped body part 184 of the yoke 18.

### (Structure of Spring Member and its Related Parts)

In the lens drive device 1 in this embodiment, one piece of spring member 14 is disposed between the movable body 3 and the support body 2. The spring member 14 may be a gimbal spring which is provided with outer peripheral side connecting parts 14a which are held by the support body 2, ring-shaped inner peripheral side connecting parts 14b which are held by the movable body 3, and a plurality of flat spring-shaped arm parts 14c for connecting the outer peripheral side connecting part 14a with the inner peripheral side connecting part 14b. The spring member 14 is made of nonmagnetic metal such as beryllium copper or nonmagnetic SUS steel material and is formed by means of that a thin plate having a predetermined thickness is performed by press working or etching processing using photo lithography technique. Further, the spring member 14 is divided into two spring pieces 14e and 14f and respective coil ends of the first coil 30x and the second coil 30y are connected with the spring pieces 14e and 14f. Further, a terminal 14d is formed in each of the spring pieces 14e and 14f and the spring member 14 (spring pieces 14e and 14f) also functions as a power supply member to the first coil 30x and the second coil 30y. In this embodiment, the arm part 14c is extended in a circular arc shape in a circumferential direction. However, the arm part 14c may be structured of a meandering part having turned-around portions in the circumferential direction, or the arm part 14c may be extended in the circumferential direction so that the arm part 14c is provided with a meandering part having turned-around portions in the radial direction.

In this embodiment, the spring member 14 is disposed between the cylindrical tube part 136, which is an end part on the imaging element side of the lens optical axis “L” direction of the movable body 3 (end part on one side in the lens optical axis “L” direction of the movable body 3), and the support body 2. In order to realize the above-mentioned structure, in this embodiment, a bottom part 135 of the coil holder 13 is formed with the cylindrical tube part 136 which is protruded toward the imaging element side around the center hole 130 where the lens holder 12 is disposed (see FIG. 2(e)). Further, the frame part 196 is formed at the outer peripheral edge of the bottom plate portion 195 of the imaging element holder 19. Therefore, when the inner peripheral side connecting parts 14b of the spring member 14 are fixed to the cylindrical tube part 136 of the coil holder 13 and the outer peripheral side connecting parts 14a of the spring member 14 are fixed to the frame part 196 of the imaging element holder 19, both ends of the arm part 14c of the spring member 14 are disposed between the end part on the imaging element side in the lens optical axis “L” direction of the movable body 3 and the support body 2.

In this state, the spring member 14 will apply spring forces in the lens optical axis “L” direction, the radial direction perpendicular to the lens optical axis “L”, and the circumferential direction around the lens optical axis “L”. Therefore, positional control in the lens optical axis “L” direction of the movable body 3 can be performed by utilizing a thrust force of the magnetic drive mechanism 5 and a spring force in the lens optical axis “L” direction of the spring member 14, and the imaging element side end part of the movable body 3 can be prevented from being displaced in the radial direction and the circumferential direction.

(Structure of Displacement Prevention Mechanism 1a)

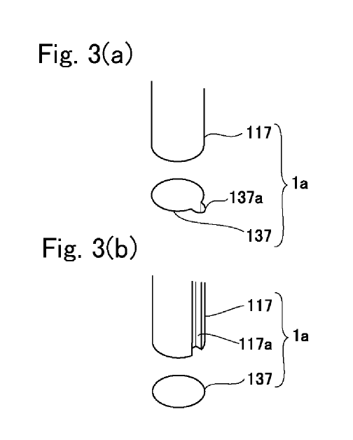

FIGS. 3(a) and 3(b) are explanatory views showing structures in which occurrence of an air damper phenomenon is prevented by the displacement prevention mechanism 1a in the lens drive device 1 to which at least an embodiment of the present invention is applied.

In the lens drive device 1 in this embodiment, the spring member 14 is disposed between the end part on the imaging element side in the lens optical axis “L” direction of the movable body 3 (end part on the one side in the lens optical axis “L” direction of the movable body 3) and the support body 2 and, in addition, a displacement prevention mechanism 1a which will be described below is structured between an end part on the object to be photographed side in the lens optical axis “L” direction of the movable body 3 (end part on the other side in the lens optical axis “L” direction of the movable body 3) and the support body 2.

In other words, the support body 2 is formed with two shaft-shaped protruded parts 117 (long and thin shaft pin) which are protruded from the face 115a (end face) on the imaging element side of the upper plate part 115 of the spacer 11 toward the imaging element side (one side in the lens optical axis “L” direction) at diagonal positions interposing the incident window 110. The movable body 3 is formed with two recessed parts 137 which are opened parts that are opened toward the object to be photographed side (the other side in the lens optical axis “L” direction) in the upper face part 134 of the coil holder 13, that is, the end part on the other side of the movable body 3. The two protruded parts 117 are respectively fitted into the recessed parts 137. The outer peripheral shape of the coil holder 13 when viewed in the lens optical axis “L” direction is rectangular but its inner peripheral shape is circular. Therefore, free spaces are formed at corner portions of the coil holder 13 and thus the recessed parts 137 are formed by utilizing the corner portions. In this embodiment, a clearance dimension between the protruded part 117 and the recessed part 137 is set in consideration of a displacement allowance in the radial direction of the movable body and its allowed amount of inclination. Further, an upper face part 134 of the coil holder 13 is formed with a ring-shaped stepped part 138 along an opening edge of the recessed part 137.

In the displacement prevention mechanism 1a structured as described above, when the movable body 3 is moved on the object to be photographed side along the lens optical axis “L”, a fitting relationship of the protruded part 117 to the recessed part 137 is maintained and an end part 117c of the protruded part 117 is abutted with a bottom part 137c of the recessed part 137 so that an excessive movement of the movable body 3 toward the object to be photographed side is prevented. Further, even when the movable body 3 is going to be displaced in the radial direction which is perpendicular to the lens optical axis “L” direction, the displacement in the radial direction is prevented by interfering of the outer peripheral face of the protruded part 117 with the inner peripheral face of the recessed part 137. In addition, a circumferential displacement of the movable body 3 which is going to turn around the lens optical axis “L” is also prevented by interfering of the outer peripheral face of the protruded part 117 with the inner peripheral face of the recessed part 137. Moreover, over all of the range that the movable body 3 is moved along the lens optical axis “L”, the protruded part 117 slides on the inner peripheral face of the recessed part 137 while being fitted into the recessed part 137. Therefore, displacement that the movable body 3 is going to incline with respect to the lens optical axis “L” is also prevented.

Further, in this embodiment, the upper face part 134 of the coil holder 13 is formed with the ring-shaped stepped part 138 along the opening edge of the recessed part 137. Therefore, an excessive displacement of the movable body 3 toward the object to be photographed side is also prevented by abutting of the stepped part 138 with the upper plate part 115 of the spacer 11. According to this structure, in comparison with a case that only abutting of the end part 117c of the protruded part 117 with the bottom part 137c of the recessed part 137 is utilized, an abutting area of the movable body 3 with the support body 2 is wider and thus the abutting portion of the movable body 3 with the support body 2 is prevented from being damaged. In accordance with an embodiment of the present invention, prevention of an excessive movement to the object to be photographed side of the movable body 3 may not be performed by abutting of the end part 117c of the protruded part 117 with the bottom part 137c of the recessed part 137. For example, an excessive movement to the object to be photographed side of the movable body 3 may be prevented by abutting of the stepped part 138 or a protruded part formed on the upper face part 134 of the coil holder 13 with the upper plate part 115 of the spacer 11.

In this embodiment, the coil (first coil 30x and second coil 30y) and the magnets 16 which are used in the magnetic drive mechanism 5 are disposed between the end part of the one side and the end part of the other side in the lens optical axis direction of the movable body. On the other hand, the displacement prevention mechanism 1a is structured by utilizing the upper plate part 115 of the spacer 11 and a portion on the upper face part 134 side of the coil holder 13. Therefore, the coil (first coil 30x and second coil 30y) and the magnets 16 which are used in the magnetic drive mechanism 5 are located in a region approximately interposed by the displacement prevention mechanism 1a and the spring member 14 in the lens optical axis “L” direction. Further, the displacement prevention mechanism 1a is structured at corner portions of the coil holder 13 and thus the displacement prevention mechanism 1a is disposed at two positions in a rotationally symmetrical relationship around the lens optical axis “L”. Therefore, when displacement of the movable body 3 is prevented by the displacement prevention mechanism 1a, the movable body 3 is surely prevented from being inclined.

In this embodiment, in order to structure the displacement prevention mechanism 1a, the protruded part 117 of the spacer 11 and the recessed part 137 of the coil holder 13 are utilized and the protruded part 117 is structured to slide within the recessed part 137. Therefore, in this embodiment, both of the spacer 11 and the coil holder 13 are made of synthetic resin to enhance their sliding properties. Further, since the spacer 11 is made of synthetic resin, the protruded part 117 can be integrally formed with the upper plate part 115 and the like and thus the protruded part 117 is not required to be formed as a separate member. Therefore, the number of part items can be reduced. In accordance with an embodiment of the present invention, the spacer 11 may be made of metal or a molded product made of inorganic insulating material in addition to a resin molded product, and the coil holder 13b may be made of nonmagnetic metal or a molded product made of inorganic insulating material in addition to a resin molded product.

In accordance with an embodiment of the present invention, it may be structured that a clearance is provided between the outer peripheral face of the protruded part 117 and the inner peripheral face of the recessed part 137 so that the outer peripheral face of the protruded part 117 and the inner peripheral face of the recessed part 137 are normally maintained in a non-contact state and, when an external force is applied, the outer peripheral face of the protruded part 117 and the inner peripheral face of the recessed part 137 are abutted with each other to restrict displacement. According to this structure, a sliding loss can be prevented from being occurred between the outer peripheral face of the protruded part 117 and the inner peripheral face of the recessed part 137.

Further, in this embodiment, the displacement prevention mechanism 1a is structured by utilizing the protruded part 117 of the spacer 11 and the recessed part 137 of the coil holder 13. Therefore, in a case that the protruded part 117 is moved within the recessed part 137, when an air damper phenomenon occurs in which air is compressed in the inside (bottom part 137c side) of the recessed part 137, an unnecessary load is applied to the movable body 3. In order to prevent occurrence of an air damper phenomenon, in this embodiment, a clearance between the recessed part 137 and the protruded part 117 is utilized. In order to further surely prevent occurrence of an air damper phenomenon, for example, as shown in FIG. 3(a), an air-vent groove 137a which is extended in the lens optical axis “L” is formed along an inner side face of the recessed part 137. According to this structure, outflow of air is performed through the groove 137a. Further, as shown in FIG. 3(b), a groove 117a which is extended in the lens optical axis “L” may be formed along the outer side face of the protruded part 117. Also in this case, outflow of air is performed through the groove 117a.

When the air vent grooves 117a and 137a (bypass) are provided, a clearance between the protruded part 117 and the recessed part 137 can be determined on the basis of restriction quantities of displacement in the radial direction, displacement in the circumferential direction, and inclination with respect to the optical axis and thus displacement prevention with a high degree of accuracy is performed. In accordance with an embodiment of the present invention, in a case that the protruded part 117 is to be moved in the recessed part 137, in order to prevent occurrence of an air damper phenomenon in which air is compressed in the inside (bottom part 137c side) of the recessed part 137, the bottom part of the recessed part 137 may be opened. Alternatively, the recessed part 137 may be formed so as to be divided into two portions in the optical axis direction. Alternatively, the recessed part 137 may be formed of only the upper face part 134 and the ring-shaped stepped part 138, and a lower side of the upper face part 134 is opened. When the recessed part 137 is formed of only the upper face part 134 of the coil holder 13 and the ring-shaped stepped part 138, the coil (first coil 30x and second coil 30y) and the magnets 16 which are used in the magnetic drive mechanism 5 are surely located in a region interposed by the displacement prevention mechanism 1a and the spring member 14 in the lens optical axis “L” direction.

### (Structure of Pressing Member 17)

In the lens drive device 1 in this embodiment, when energization to the first coil 30x and the second coil 30y which are used in the magnetic drive mechanism 5 is not performed, the movable body 3 is located on the imaging element side and the bottom part of the movable body 3 (bottom part 135 of the coil holder 13) is abutted with the projections 197 of the imaging element holder 19. The position of the movable body 3 in this state is the home position.

In this embodiment, during a time when energization to the first coil 30x and the second coil 30y is not performed, in order to hold the movable body 3 at the home position, a pressing member 17 is fixed on the upper face part 134 located on the object to be photographed side of the coil holder 13 of the movable body 3. The pressing member 17 is a metal flat spring, which is provided with a rectangular fixing frame part 171 and two flat spring parts 172 that are cut and bent from an inner circumferential edge of the fixing frame part 171 at diagonal positions of the fixing frame part 171. The flat spring part 172 is provided with a base part 172a having a thin width which is obliquely extended from the fixing frame part 171 toward the object to be photographed side and a tip end part 172b which is bent at a tip end of the base part 172a to be extended in parallel to the fixing frame part 171 (see FIG. 2(b)).

The upper face part 134 of the coil holder 13 is formed with a frame part 139 which is protruded in a low height on the object to be photographed side along its outer peripheral edge. The fixing frame part 171 of the pressing member 17 is fixed on the upper face part 134 of the coil holder 13 so as to be located on an inner side of the frame part 139. Therefore, when the lens drive device 1 is assembled so that the spacer 11 is disposed on the object to be photographed side of the movable body 3, the tip end part 172b of the flat spring part 172 of the pressing member 17 is pressed toward the imaging element side by the face 115a on the imaging element side of the upper plate part 115 of the spacer 11. As a result, since the pressing member 17 presses the movable body 3 toward the imaging element side, the movable body 3 is resiliently held at the home position where the projections 197 of the imaging element holder 19 are abutted with the bottom part 135 of the coil holder 13. Therefore, even when an external force is applied, the movable body 3 is surely held at the home position. Further, the pressing member 17 presses the movable body 3 at two rotationally symmetrical positions with the lens optical axis “L” as a center and thus pressing forces at two rotationally symmetrical positions around the lens optical axis “L” are applied to the movable body 3. Therefore, when the movable body 3 is driven by the magnetic drive mechanism 5, the movable body 3 is not inclined.

### (Basic Operation)

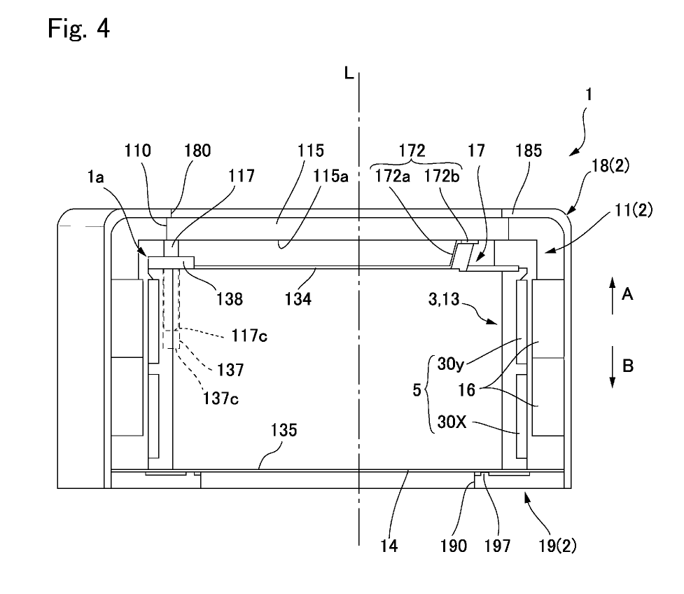

FIG. 4 is an explanatory view schematically showing an operation of the lens drive device 1 to which at least an embodiment of the present invention is applied. In the lens drive device 1 in this embodiment, the movable body 3 is normally located on the imaging element side (home position) and this state is maintained by the pressing force of the pressing member 17. In this state, the spring member 14 is not deformed and a spring force is not generated. In accordance with an embodiment of the present invention, in the state that the movable body 3 is located at the home position, it may be structured that the spring member 14 urges the movable body 3 toward the imaging element side or toward the object to be photographed side.

In this state, when an electric current is supplied to the first coil 30x and the second coil 30y in a predetermined direction, an upward (front side) electro-magnetic force is applied to each of the first coil 30x and the second coil 30y. Therefore, the movable body 3 which holds the first coil 30x and the second coil 30y begins to move toward the object to be photographed side (front side). In this case, an elastic force for restricting movement of the movable body 3 is generated in the spring member 14. Further, the pressing member 17 also applies an elastic force for restricting movement of the movable body 3. Therefore, when an electro-magnetic force by the magnetic drive mechanism 5 which is going to move the movable body 3 to the front side and elastic forces by the spring member 14 and the pressing member 17 for restricting the movement of the movable body 3 are balanced with each other, the movable body 3 is stopped.

In this case, when an amount of an electric current supplied to the first coil 30x and the second coil 30y is adjusted depending on the elastic forces applied to the movable body 3 by the spring member 14 and the pressing member 17, the movable body 3 is stopped at a desired position. Further, large balanced forces are utilized in the lens optical axis “L” direction and thus, even when other forces such as a centrifugal force or an impact force are acted in the lens optical axis “L” direction, the movable body 3 can be stopped in a stable state. In addition, in the lens drive device 1, in order to stop the movable body 3, instead of making the movable body 3 collide with a collided member (buffer material) or the like, the movable body 3 is stopped by utilizing a balance of the electro-magnetic force with the elastic force and thus a collision noise is prevented.

(Principal Effects in this Embodiment)

As described above, in the lens drive device 1 in this embodiment, only one piece of the spring member 14 formed in a gimbal spring shape which is provided with the arm parts 14c is used at an end part on the imaging element side (end part on one side) in the lens optical axis “L” direction of the movable body 3 and thus a spring force of the spring member 14 can be made larger in comparison with a conventional case that two pieces of spring are used. Therefore, even when a weight of the movable body 3 is reduced or a thrust force generated by the magnetic drive mechanism 5 is reduced with downsizing of the movable body 3, the arm part 14c has a margin so that its thickness and width can be made thinner. Accordingly, strength, a spring characteristic, a stress resistance performance and the like of the spring member 14 are not lowered. Therefore, in the manufacturing steps of the lens drive device 1, handling of the spring member 14 is easy. Further, when only one piece of the spring member 14 is used, the number of part items is decreased and thus the cost is reduced. Further, when only one piece of the spring member 14 is used, the optical axis of the movable body 3 is easily adjusted in comparison with a case that two pieces of spring member are used.

In this case, displacement in the radial direction, a circumferential displacement of the movable body and inclination of the movable body are easily occurred at the end part on the object to be photographed side (end part on the other side) of the movable body 3. However, in this embodiment, the displacement prevention mechanism 1a is structured at the object side end part of the movable body 3 by using the protruded part 117 protruded in the lens optical axis “L” direction and the recessed part 137 into which the protruded part 117 is fitted so as to prevent an excessive movement than a predetermined distance in the lens optical axis direction “L” of the movable body 3, displacement in the radial direction of the movable body 3, circumferential displacement of the movable body 3, and inclination of the movable body 3. Therefore, even when one spring member 14 is used, unnecessary displacement of the movable body 3 can be restrained.

In addition, the displacement prevention mechanism 1a which is structured as described above utilizes both end faces of the movable body 3 and the support body 2 (the face 115a on the imaging element side of the upper plate part 115 of the spacer 11 and the upper face part 134 of the coil holder 13) which are faced with each other in the lens optical axis “L” direction and thus, a space for providing the displacement prevention mechanism 1a is not required between the support body 2 and the movable body 3 in the radial direction. Therefore, the displacement prevention mechanism 1a in this embodiment is suitable for a small lens drive device 1, especially for a lens drive device 1 whose dimension in the radial direction is small.

In addition, in the displacement prevention mechanism 1a, only one mechanism prevents an excessive movement than a predetermined distance in the lens optical axis direction “L” of the movable body 3, displacement in the radial direction of the movable body 3, inclination of the movable body 3, and circumferential displacement of the movable body 3. Therefore, even when the movable body 3 is going to turn around the lens optical axis “L” by an impact applied from the outside, a circumferential force is not applied to the spring member 14 from the movable body 3. Accordingly, even in a case that one piece of the spring member 14 is used, a fatal malfunction such as plastic deformation is not occurred in the spring member 14.

Further, the coil (first coil 30x and second coil 30y) and the magnets 16 which are used in the magnetic drive mechanism 5 are disposed so as to be interposed by the displacement prevention mechanism 1a and the spring member 14 in the lens optical axis “L” direction. Therefore, in comparison with a case that the magnetic drive mechanism 5 is disposed on one side in the lens optical axis direction “L”, when the movable body 3 is driven by the magnetic drive mechanism 5, the movable body 3 is not inclined. Further, a region in the lens optical axis “L” direction between the spring member 14 and the displacement prevention mechanism 1a is utilized as an arrangement space for the magnetic drive mechanism 5 and thus the size of the lens drive device 1 is suitably reduced.

In addition, in this embodiment, the lens 121 is circular but, regardless of the shape of the lens, the first coil 30x and the second coil 30y are formed in a quadrangular shape. Further, the magnet 16 is a flat plate-shaped permanent magnet which is fixed to each of a plurality of inner faces corresponding to sides of the rectangular tube-shaped body part 184 of the yoke 18 whose inner peripheral face is formed in a quadrangular shape in the support body 2. Therefore, even when a sufficient space is not secured on the outer peripheral side of the movable body 3 between the movable body 3 and the support body 2, a facing area of the first coil 30x and the second coil 30y with the magnets 16 are large and thus a sufficient thrust force can be obtained.

Further, the support body 2 and the movable body 3 are provided with an external shape which is a substantially rectangular parallelepiped shape and the displacement prevention mechanism 1a is disposed at corner portions of the support body 2 and the movable body 3 when viewed in the lens optical axis “L” direction. When viewed in the lens optical axis “L” direction, the outer peripheral shape of the coil holder 13 is rectangular but its inner peripheral shape is circular and thus the corner portions of the coil holder 13 are free spaces where the circular lens 121 and the magnets 16 are not disposed. In this embodiment, since the displacement prevention mechanism 1a is disposed at the free space position, even when the size of the lens drive device 1 is reduced, the displacement prevention mechanism 1a can be reasonably disposed.

### Other Embodiments

In the embodiment described above, the spring member 14 formed in a gimbal spring shape which is provided with the arm parts 14c is disposed at the end part on the imaging element side in the lens optical axis “L” direction of the movable body 3 and the displacement prevention mechanism 1a is disposed at the end part on the object to be photographed side of the movable body 3. However, the spring member 14 formed in a gimbal spring shape which is provided with the arm parts 14c may be disposed at the end part on the object to be photographed side in the lens optical axis “L” direction of the movable body 3, and the displacement prevention mechanism 1a is disposed at the end part on the imaging element side of the movable body 3. Further, an abutting part for preventing displacement in the radial direction and circumferential displacement of the movable body 3 may be also provided on the side where the spring member 14 is disposed. According to this structure, plastic deformation and the like of the spring member 14 can be prevented surely.

In the embodiment described above, the recessed part 137 is formed in the movable body 3 and the protruded part 117 is formed in the support body 2. However, the protruded part may be formed in the movable body 3 and the recessed part is formed in the support body 2.

In the embodiment described above, the home position of the movable body 3 is located on the imaging element side and thus the movable body 3 is pressed toward the imaging element side by the pressing member 17. However, in a case that the home position of the movable body 3 is set to be located on the object to be photographed side, the movable body 3 is pressed toward the object to be photographed side by the pressing member 17.

In the embodiment described above, a flat spring is used as the pressing member 17. However, it may be structured that a magnetic piece is mounted on the movable body 3 as the pressing member and the movable body 3 is pressed toward the home position by a magnetic attraction force acted between the magnetic piece and the magnets 16.

Further, it may be structured that, in the state that the movable body 3 is located at the home position, the spring member 14 urges the movable body 3 toward the home position. In this case, no pressing member 17 may be provided.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

1. A lens drive device for driving a lens, the lens drive device comprising:
a support body;
a movable body which holds the lens;
a magnetic drive mechanism which drives the movable body in a lens optical axis direction; and
a spring member which is provided with an arm part whose both ends are connected with the movable body and the support body;
wherein only one piece of the spring member is disposed between an end part on one side in a lens optical axis direction of the movable body and the support body; and wherein a displacement prevention mechanism is structured at an end part on the other side in the lens optical axis direction of the movable body, the displacement prevention mechanism being comprised of a protruded part which is extended in the lens optical axis direction from one of the movable body and the support body and a recessed part which is provided in the other of the movable body and the support body and opened in the lens optical axis direction and into which the protruded part is fitted so that displacement in a radial direction perpendicular to the lens optical axis direction of the movable body, circumferential displacement around the lens optical axis of the movable body, and inclination of the movable body with respect to the lens optical axis are prevented.

2. The lens drive device according to claim 22, wherein the displacement prevention mechanism is structured so that an excessive movement of the movable body in the lens optical axis direction is also prevented by the end part of the protruded part and the bottom part of the recessed part.

3. (canceled)

4. (canceled)

5. The lens drive device according to claim 22, wherein
each of the support body and the movable body is provided with an external shape which is substantially a rectangular prism shape, and
the displacement prevention mechanism is disposed at a position corresponding to corner portions of the support body and the movable body when viewed in the lens optical axis direction.

6. The lens drive device according to claim 5, wherein the magnet which is used in the magnetic drive mechanism is a flat plate-shaped permanent magnet that is disposed at a position corresponding to a side portion of the support body when the support body is viewed in the lens optical axis direction.

7. The lens drive device according to claim 6, wherein the displacement prevention mechanism is disposed at plural rotationally symmetrical positions with the lens optical axis as a center.

8. The lens drive device according to claim 7, further comprising a pressing member which presses the movable body toward a home position where the movable body is located in a state that the magnetic drive mechanism does not generate a thrust force in the lens optical axis direction,
wherein the pressing member applies rotationally symmetrical pressing forces to the movable body with the lens optical axis as a center.

9. (canceled)

10. The lens drive device according to claim 5, wherein
the magnet which is used in the magnetic drive mechanism is a flat plate-shaped permanent magnet that is disposed at a position corresponding to a side portion of the support body when the support body is viewed in the lens optical axis direction,
the coil which is used in the magnetic drive mechanism is wound around in a rectangular tube shape so as to face the flat plate-shaped permanent magnet, and
the protruded part and the recessed part which structure the displacement prevention mechanism are disposed on an inner side at a corner portion of the coil which is formed in a rectangular tube shape.

11. The lens drive device according to claim 10, wherein
the movable body is provided with a lens holder in a cylindrical tube shape which holds the lens and a rectangular coil holder which holds the lens holder on an inner side and whose outer peripheral side face is wound around with the coil, and
the displacement prevention mechanism is structured on an inner side of a corner portion of the rectangular coil holder and between the lens holder in the cylindrical tube shape and the rectangular coil holder.

12. The lens drive device according to claim 11, wherein
the protruded part is a shaft pin which is protruded from the support body in a long and thin shape in the lens optical axis direction, and
the recessed part is provided with an opening part which is formed in the coil holder so that the shaft pin is fitted.

13. The lens drive device according to claim 1, wherein
the protruded part is protruded from the support body in the lens optical axis direction and the recessed part into which the protruded part is fitted is formed in the movable body,
the protruded part is formed in a length that an end part of the protruded part is moved within the recessed part, and
the end part of the protruded part is always fitted into the recessed part when the movable body is moved along the lens optical axis.

14. The lens drive device according to claim 13, wherein
each of the support body and the movable body is provided with an external shape which is substantially a rectangular prism shape,
the magnet which is used in the magnetic drive mechanism is a flat plate-shaped permanent magnet that is disposed at a position corresponding to a side portion of the support body when the support body is viewed in the lens optical axis direction,
the coil which is used in the magnetic drive mechanism is wound around in a rectangular tube shape so as to face the flat plate-shaped permanent magnet, and
the protruded part and the recessed part which structure the displacement prevention mechanism are disposed on an inner side at a corner portion of the coil which is formed in a rectangular tube shape.

15. (canceled)

16. The lens drive device according to claim 15, wherein
the movable body is provided with a lens holder in a cylindrical tube shape which holds the lens and a rectangular coil holder which holds the lens holder on an inner side and whose outer peripheral side face is wound around with the coil, and
the displacement prevention mechanism is structured on an inner side of a corner portion of the rectangular coil holder and between the lens holder in the cylindrical tube shape and the rectangular coil holder.

17. The lens drive device according to claim 16, wherein
the protruded part is a shaft pin which is protruded from the support body in a long and thin shape in the lens optical axis direction, and
the recessed part is provided with an opening part which is formed in the coil holder so that the shaft pin is fitted.

18. The lens drive device according to claim 15, wherein the displacement prevention mechanism is disposed at plural rotationally symmetrical positions with the lens optical axis as a center.

19. The lens drive device according to claim 18, further comprising a pressing member which presses the movable body toward a home position where the movable body is located in a state that the magnetic drive mechanism does not generate a thrust force in the lens optical axis direction.

20. The lens drive device according to claim 19, wherein the pressing member applies rotationally symmetrical pressing forces to the movable body with the lens optical axis as a center.

21. (canceled)

22. The lens drive device according to claim 1, wherein the recessed part is a recessed part having a bottom part, and the protruded part is a protruded part having an end part which faces the bottom part of the recessed part.

23. The lens drive device according to claim 2, further comprising an air damper phenomenon prevention structure which is provided between an inner peripheral face of the recessed part and an outer peripheral face of the protruded part for preventing occurrence of an air damper phenomenon in which air is compressed at the bottom part of the recessed part when the protruded part is moved in the recessed part.

24. The lens drive device according to claim 23, wherein the air damper phenomenon prevention structure includes an air-vent groove which is provided on the inner peripheral face of the recessed part so as to be extended in the lens optical axis direction.

25. The lens drive device according to claim 23, wherein the air damper phenomenon prevention structure includes an air-vent groove which is provided on the outer peripheral face of the protruded part so as to be extended in the lens optical axis direction.
